(19) United States
(12) Patent Application Publication
(10) Pub. No.: US 2024/0005013 A1
(43) Pub. Date: Jan. 4, 2024

(54) Testing-and-Manufacturing Keys for a System-on-Chip

(71) Applicant: Google LLC, Mountain View, CA (US)

(72) Inventors: Andrei Tudor Stratan, San Jose, CA (US); Randall R. Spangler, San Jose, CA (US)

(73) Assignee: Google LLC, Mountain View, CA (US)

(21) Appl. No.: 18/249,698

(22) PCT Filed: Oct. 27, 2020
(86) PCT No.: PCT/US2020/057504

§ 371 Date: Apr. 19, 2023

(51) Int. Cl. G06F 21/62; G06F 21/44; G06F 11/22

(52) U.S. Cl. CPC G06F 21/62; G06F 21/44; G06F 11/2273

(57) ABSTRACT

Systems and techniques are described for implementing testing-and-manufacturing keys for a system-on-chip (SoC). A hardware test portion of the SoC is configured to exercise features of domains that process data being communicated across the fabrics during an externally initiated test. In response to receiving a testing-and-manufacturing token from an external test system, a testing-and-manufacturing key support component of the SoC generates a testing-and-manufacturing key. The hardware test portion is configured to execute a test function to promote security of the SoC, however, only in response to the testing-and-manufacturing security component authenticating the testing-and-manufacturing key. Through implementing testing-and-manufacturing keys this way, the system-on-chip secures access to potentially sensitive functions and secrets, while allowing their unencumbered and authorized access for testing the system-on-chip during various life cycle states.

### BACKGROUND

A system-on-chip (SoC) may include multiple domains, including a processing domain (e.g., central processing core, graphics processing core) and a support or feature domain (e.g., providing power-management, security, access, always-on capability, options to run secure or non-secure code, and provisioning). Through implementing a number of sequential lifecycle states, the system-on-chip ties several domains together into a feature set of a single chip. The limited features offered in these states may constrain the ability to test the system-on-chip or the device that incorporates it. The system-on-chip may offer debug access and test functions that allow an external system to monitor or take control of the system-on-chip for debugging and testing. However, these are potential entry points for attacks, which risks exposing secrets maintained by the system-on-chip. Security measures may be deployed around the debug access and test functions, which in turn make using these functions relatively cumbersome. Moreover, the debug and test functionality may itself be feature-limited or restricted during one or more of the lifecycle states, further reducing ease-of-use.

### SUMMARY

This document describes systems and techniques for implementing testing-and-manufacturing keys for a system-on-chip. In some aspects, a method is described including receiving, by a system-on-chip, from an external test system, a testing-and-manufacturing token for the external test system. The method further includes generating, by the system-on-chip, based on the testing-and-manufacturing token, a testing-and-manufacturing key for authorizing access to test functions of the system-on-chip. The method further includes attempting authentication of the testing-and-manufacturing key based on a secret key maintained by the system-on-chip, and responsive to authenticating the testing-and-manufacturing key based on the secret key, outputting, to the external test system, an indication of whether one or more domains or one or more fabrics of the system-on-chip passed or failed a test involving the test functions of the system-on-chip. Through implementing testing-and-manufacturing keys through this method, the system-on-chip secures access to potentially sensitive functions and secrets, while allowing their unencumbered and authorized access for testing the system-on-chip during various life cycle states.

This document also describes a system-on-chip configured to perform the above-summarized method, as well as a computer-readable media having executable instructions that, when executed, cause a system-on-chip of a computing device to perform the above-summarized method. Other methods are set forth herein, as well as systems and means for performing the above-summarized and other methods.

This summary is provided to introduce simplified concepts for implementing testing-and-manufacturing keys for a system-on-chip, which are further described below in the Detailed Description and Drawings. This summary is not intended to identify essential features of the claimed subject matter, nor is it intended for use in determining the scope of the claimed subject matter.

### BRIEF DESCRIPTION OF THE DRAWINGS

The details of systems and techniques for implementing testing-and-manufacturing keys for a system-on-chip are described in this document with reference to the following drawings. The same numbers are used throughout the drawings to reference like features and components.

FIG. 1 illustrates an example system-on-chip that is configured to implement testing-and-manufacturing keys in accordance with techniques of this disclosure.

FIG. 2 illustrates another example system-on-chip that is configured to implement testing-and-manufacturing keys in accordance with techniques of this disclosure.

FIG. 3 illustrates an example token structure for a testing-and-manufacturing token in accordance with techniques of this disclosure.

FIG. 4 illustrates another example system-on-chip that is configured to implement testing-and-manufacturing keys in accordance with techniques of this disclosure.

FIG. 5 illustrates an example computing environment in which an example system-on-chip that is configured to implement testing-and-manufacturing keys in accordance with techniques of this disclosure.

FIG. 6 illustrates an example process performed by an example system-on-chip that is configured to implement testing-and-manufacturing keys in accordance with techniques of this disclosure.

### DETAILED DESCRIPTION

Overview

This document describes systems and techniques for enabling testing-and-manufacturing (TM) keys for a system-on-chip. A system-on-chip may include multiple domains, including processing cores (e.g., central processing, graphics processing) and domains that provide other support features, for example power management, security, access, always-on capabilities, options to run secure or non-secure code, and provisioning the device with secrets.

During test and regular operations, the system-on-chip generates data and executes instructions. For storing the data and these instructions, the system-on-chip may further include an interface to Volatile Memory (VM) (e.g., random access memory, DRAM) and Non-Volatile Memory (NVM) (e.g., Flash memory). The former is used for code execution, and the NVM stores the code prior to its execution. Communication fabrics or busses of the system-on-chip, which may be organized hierarchically based on capabilities and performance, transfer data between the various domains. The system-on-chip may have external interfaces, for example to a general-purpose bus or to specialized ports, for instance, a camera or a display port.

By transitioning through a sequence of lifecycle states, the system-on-chip ties together these several features and functionalities. For illustrative purposes, the system-on-chip may operate according to the following four lifecycle states. The following states are listed as an illustration only; additional or other life cycle states may be used:
An open state where no security features are enabled, and the system-on-chip is completely or partially unprovisioned.
A development state where some security features are active and some test features are enabled, and provisioning of the system-on-chip may be enabled or optional.
A production state where security is fully enabled, and the system-on-chip is completely provisioned and ready to operate or ship to end-users. The production state is the state the system-on-chip is in when incorporated into endpoint devices.
A root analysis state where the system-on-chip cannot execute production code, and its capabilities are limited to those necessary for diagnosing technical issues with the system-on-chip.
   The system-on-chip changes life cycle states by progressing from the open state to the development state and eventually to the production state, where the system-on-chip undergoes manufacturing, testing, and provisioning before being shipped in a device. For security reasons, transitions between two life cycle states may be one-way transitions, so the system-on-chip cannot return to a previous lifecycle state (e.g., except for a modification of the system-on-chip requiring chip-manufacturing tools). The system-on-chip may eventually progress to the root analysis state after a device or the system-on-chip is returned for failure analysis.

At times, the functionality of the system-on-chip may need testing. The system-on-chip typically provides debug access and test functions through a physical interface that may be dedicated or shared with other functions. Typically, the debug access and test functions allow an external system to either monitor or take control of the system-on-chip, subject to security constraints. These debug access and test functions can be invasive operations where an external computing environment takes control of a processing element of the system-on-chip, and they can interfere with code execution or may load and execute externally supplied code. In other examples, the debug access and test functions can be non-invasive operations where an external computing environment monitors or extracts data from the system-on-chip, for example, in response to a code-execution failure.

Both types of debug access and test functions are able to modify or observe a processing element of a system-on-chip including the processing element's code flow, and, therefore, each is at risk of exposing secrets maintained by the system-on-chip. That is, the debug access and test functions are potential entry points for attacks, and the system-on-chip takes extensive security measures, which, in turn, makes using the debug access and test functions for production support to be relatively cumbersome. Moreover, functionality of debug access and test functions may be conditioned by the lifecycle state, further reducing ease-of-use. The lifecycle states of the system-on-chip may constrain the ability to test the system-on-chip or the device that incorporates it.

In this disclosure, systems and techniques are described for implementing testing-and-manufacturing keys for a system-on-chip. A system-on-chip includes one or more fabrics and one or more domains that process data being communicated across the fabrics. A hardware test portion of the system-on-chip is configured to exercise features of the domains and the fabrics during an externally initiated test. In response to receiving a testing-and-manufacturing token from an external test system, a testing-and-manufacturing key support component of the system-on-chip generates a testing-and-manufacturing key. The hardware test portion, however, is configured to execute a test function to promote security of the system-on-chip only in response to authenticating the testing-and-manufacturing key. Through implementing testing-and-manufacturing keys through this method, the system-on-chip secures access to potentially sensitive functions and secrets, while allowing their unencumbered and authorized access for testing the system-on-chip during various life cycle states.

### Example Environment

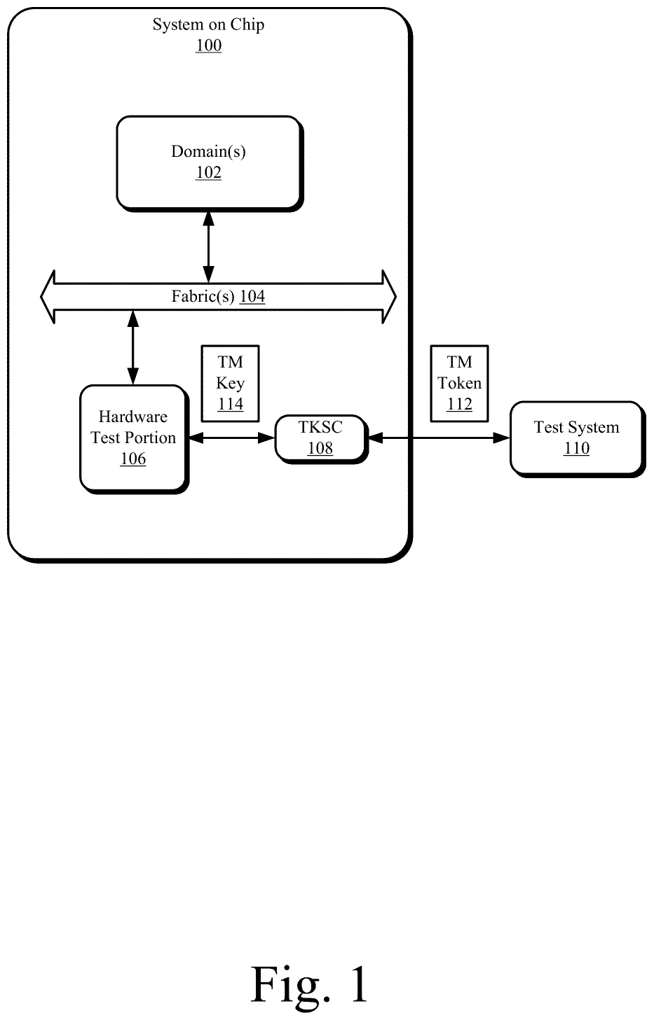

FIG. 1 illustrates an example system-on-chip that is configured to implement testing-and-manufacturing keys in accordance with techniques of this disclosure. A system-on-chip 100 includes one or more domains 102 that interface with one or more communication fabrics 104 (also referred to as “fabrics 104”).

The domains 102 represent processing cores (e.g., central processor, graphics processor) and other support features (e.g., power management, security, always-on) of the system-on-chip 100. The fabrics 104 represent a transport layer or links between these domains 102 and the hardware test portion 106. Examples of the fabrics 104 include core and main fabrics that link the domains 102 to a computer-readable storage media of the system-on-chip 100 (not shown) (e.g., a volatile memory) and media and system busses that interconnect the support features of the system-on-chip 100 to another computer-readable storage media (not shown) (e.g., a non-volatile memory), and other busses. The fabrics 104 communicate data that is used for executing operations of the system-on-chip 100, including operations related to a test. During a test, functions of the system-on-chip 100 are executed, which exercise the domains 102 and/or the fabrics 104.

The system-on-chip 100 changes life cycle states by progressing from an open state to a development state and eventually to a production state, where the system-on-chip 100 undergoes manufacturing, testing, and provisioning, prior to being shipped in a device. If the device or the system-on-chip 100 is returned for failure analysis, the system-on-chip may enter a root analysis state. These are just some example lifecycle states; the system-on-chip 100 may include any quantity of lifecycle states, each of which may inhibit testing the system-on-chip 100. For security reasons, transitions between two life cycle states of the system-on-chip 100 are one-way transitions, which prevents the system-on-chip 100 from returning to a previous lifecycle state. The system-on-chip 100 may be capable of returning to a previous lifecycle state. Special tools or processes, however, may be required. Each of the different lifecycle states can constrain a test; the test system 110 may be limited in ability to fully exercise the domains 102 and the fabrics 104 to test the system-on-chip 100, for instance, because of some immutable feature of the system-on-chip 100 that is tied to a current lifecycle state.

An external computing system acts as a test system 110 (e.g., any computing device, computer, terminal, or server) and communicates with the system-on-chip 100 to initiate a test of the domains 102 and the fabrics 104. The test system 110 directs the test by selecting a testing-and-manufacturing token 112 (referred to simply as “TM token 112”) to send to the system-on-chip 100. No matter the current lifecycle state of the system-on-chip 100, the system-on-chip 100 is configured to permit testing of the domains 102 and the fabrics 104 by controlling access through authentication of a testing-and-manufacturing key 114 (referred to simply as “TM key 114”). The TM key 114 is generated based on the TM token 112 and authenticated based on a secret key maintained by the SoC.

Unlike other systems on chip, the system-on-chip 100 includes a hardware test portion 106 and a testing-and-manufacturing key support component 108 (also referred to as “TKSC 108”). The hardware test portion 106 and the TKSC 108 are configured to implement testing-and-manufacturing keys that permit the system-on-chip 100 to perform specific testing operations that are otherwise not enabled in a current life cycle state. Rather than be constrained by limitations of a current lifecycle state, the hardware test portion 106 and TKSC 108 are configured to exercise the domains 102 and fabrics 104 as part of testing the system-on-chip 100 according to a test that is orchestrated by the test system 110. The TKSC 108 prevents external access to the hardware test portion 106, which conducts tests of the system-on-chip 100-1. The TKSC 108 is configured to receive the TM token 112 and, in response to the TM token 112, generate the TM key 114, which is then authenticated based on the secret key.

FIG. 2 illustrates another example system-on-chip that is configured to implement testing-and-manufacturing keys in accordance with techniques of this disclosure. A system-on-chip 100-1 is an example of the system-on-chip 100 shown in FIG. 1. The system-on-chip 100-1 includes a physical interface 200 that links to a test system 110-1, which is an example of the test system 110. The physical interface 200 can be a dedicated test port (e.g., a joint test action group interface) or a commonly used serial port, for example a universal serial bus or universal asynchronous receiver/transmitter. The test system 110-1 is configured to receive input 202 via a user interface or machine interface. Based on the input 202, the test system 110-1 generates the TM token 112.

The system-on-chip 100-1 further includes a TKSC 108-1 as an example of the TKSC 108. The system-on-chip 100-1 receives the TM token 112 using the TKSC 108-1, which is physically coupled to the test system 110-1. To ensure security of the system-on-chip 100-1, the physical interface 200 may be the only part of the system-on-chip 100-1 that is coupled to the test system 110-1. In this way, the TKSC 108-1 and the physical interface 200 are configured to prevent the test system 110-1 from accessing the hardware test portion 106-1, which has access over portions of the domains 102 and the fabrics 104. The TKSC 108-1 is configured to generate the TM key 114 and one or more parameters 204 based on the TM token 112 received via the physical interface 200. In sum, the TKSC 108-1 is configured to generate the TM key 114 when physically coupled to the test system 110-1.

The TKSC 108-1 may go dormant and operate in a powered off or standby state when the physical interface 200 is decoupled from the test system 110-1. The system-on-chip 100-1 transitions the TKSC 108-1 from operating in a dormant state to a wake state in response to detecting the test system 110-1 being physically coupled to the system-on-chip 100-1. This way, the system-on-chip 100-1 does not have to provide resources (e.g., electrical power) to the TKSC 108-1 except if the physical interface 200 senses a physical connection to the test system 110-1 or other equipment.

A hardware test portion 106-1 is an example of the hardware test portion 106 and receives information from the TKSC 108-1 to conduct a test of the domains 102 and the fabrics 104. The hardware test portion 106-1 is at least communicatively isolated from the test system 110-1 by way of the TKSC 108-1 and the physical interface 200, each of which is separate from the hardware test portion 106-1. Like the TKSC 108-1, the hardware test portion 106-1 may also lie dormant to conserve electrical power unless woken up for a test. For example, at the start of a test, the hardware test portion 106-1 receives a wake-up signal at a socket 206 from the TKSC 108-1. The wakeup signal causes the hardware test portion 106-1 to reset or initialize registers 208-1 and 208-2. In some cases, the parameters 204 indicate initial values or states for initializing the registers 208-1 and 208-2 or other aspects of the hardware test portion 106.

By design, the hardware test portion 106-1 has a high level of security. The hardware test portion 106 is able to take control of major functional blocks of the system-on-chip 100-1 for test purposes only. The hardware test portion 106-1 may be limited in its ability to take control only while the appropriate TM key 114 is active and the physical interface 200 has a connection to the test system 110-1. While able to conduct a test of the domains 102 and the fabrics 104, the hardware test portion 106-1 may be incapable of disabling or diverting code execution or otherwise interfere with the boot processes on the system-on-chip 100-1 if such processes are present and enabled. When not undergoing testing, the secret key maintained by the TKSC 108 is inactive and inaccessible. An additional safety feature of the hardware test portion 106-1 is its inability to change a lifecycle state of the system-on-chip 100-1 if a lifecycle state variable is maintained. Further, the hardware test portion 106-1 is unable to execute instructions that change a security level, if one is set, and is unable to execute instructions that modify execution privileges or otherwise change the security status of any on-chip core or execution element with which it interacts. For example, the hardware test portion 106-1 cannot escalate code execution privileges from a user to a kernel level.

The TKSC 108-1 maintains a secret key 210. The functionality of the system-on-chip 100-1 is verified based on information contained in the TM key 114 and using the secret key 210, which is maintained as part of the TKSC 108-1 in a secure portion of the system-on-chip 100-1. The secret key 210 can be a global key and reused in a production batch or between multiple batches of the system-on-chip 100-1. The TKSC 108-1 may store the secret key 210 in a read-only memory or as part of execution of a run-time library. Using the secret key 210, the TKSC 108-1 is configured to attempt authentication of the TM key 114.

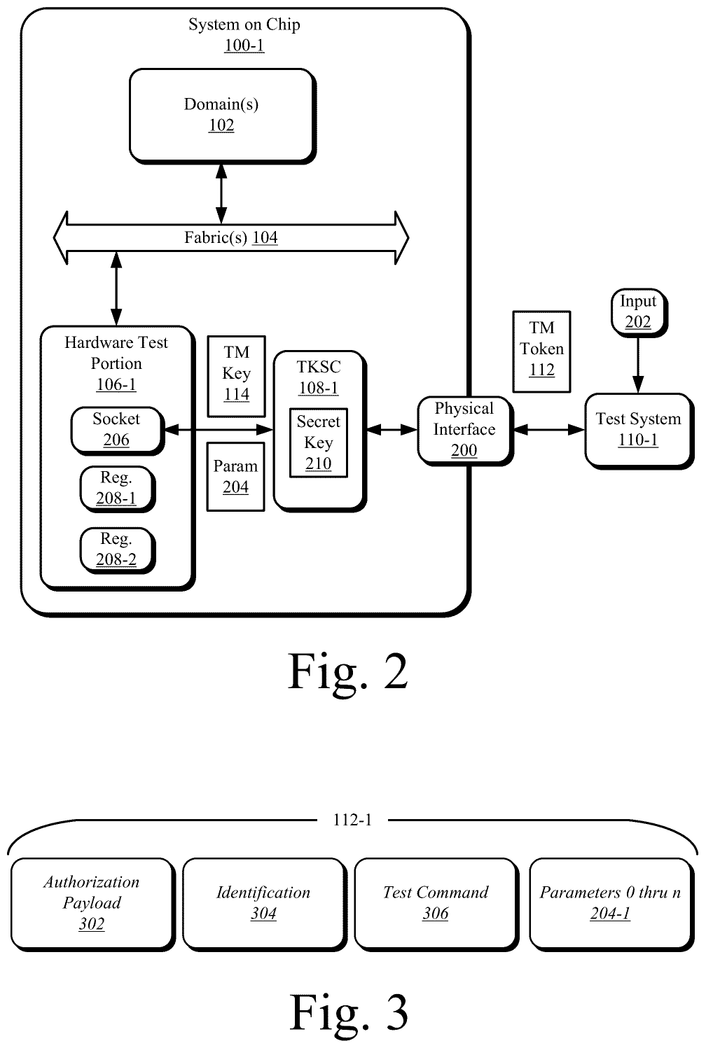

After authentication, the TKSC 108-1 delivers the TM key 114 and the parameters 204 via the socket 206 by writing to the socket 206 in a format similar to the token structure 300 shown in FIG. 3. The hardware test portion 106-1 is configured to receive a signal indicative of the TM key 114 from the TKSC 108-1. In some examples, the signal is further indicative of the parameters 204, which can be used as inputs to the test functions.

The TKSC 108-1 is configured to function as soon as the physical interface 200 of the system-on-chip 100-1 is operational. This requires the system-on-chip 100-1 to maintain a minimum level of test support resources, on which the TKSC 108-1, and later the hardware test portion 106, can operate. The physical interface 200 may provide a limited amount of input and output capability, power signals, clock signals, and so on. For example, an internal clock generated by the system-on-chip 100-1 can be provided to the test system 110-1 via the physical interface 200.

Together with the hardware test portion 106-1, the TKSC 108-1 is configured to operate independently of the domains 102 and the fabrics 104 of the system-on-chip 100-1. In other words, the TKSC 108-1 and the hardware test portion 106-1 have no dependence on a functional central processing unit, a working read-only memory, or a working on-chip flash or other similar resources that are separate and operate independently from the TKSC 108-1 and the hardware test portion 106-1. The TKSC 108-1 and the hardware test portion 106-1 are configured to operate consistently, even if any of the domains 102 or the fabrics 104 is inoperable.

In some examples, the TKSC 108-1 generates and maintains multiple TM keys. In such a case, the TKSC 108-1 may not require all available TM keys to be activated on power-up. Certain operations that these keys enable would only be able to run on fully tested and provisioned system-on-chips due to potential functional dependencies and should therefore be deferred until testing and potentially provisioning (if applicable) has been successfully completed. For example, if more than one TM key 114 is available in the system-on-chip 100-2, the TKSC 108-1 may determine which of the TM keys applies to the TM token 112 before attempting to authenticate or verify the TM key 114.

FIG. 3 illustrates an example token structure 300 for a testing-and-manufacturing token in accordance with techniques of this disclosure. The token structure 300 includes a token 112-1, as an example of the TM token 112. The token 112-1 includes multiple parts. An authorization payload 302 of the token 112-1 provides information TKSC 108 and TKSC 108-1 used to generate the TM key 114. The token structure further includes an identification segment 304, which is an identifier indicative of the domains 102 and/or the fabrics 104 intended for a test. The TKSC 108 may determine which subsystem of the system-on-chip 100-2 should be tested and then forward the TM key 114 and associated parameters 204-1 to the hardware test portion 106-1 for testing. The TKSC 108 may generate the TM key 114 based in part on the authorization payload 302 and the identification segment 304. In this way, the TKSC 108 can generate a TM key that is unique to the test system that sends the TM token 112.

Also shown in FIG. 3, the TM token 112-1 includes a test command 306 and one or more parameters 204-1. The test system 110 may modify the TM token 112-1 to specify a particular one of the domains 102 or the fabrics 104 to test by populating the TM token 112-1 with a particular test command and specific parameters for the test. This way, responsive to authenticating the TM key 114 based on the secret key, the hardware test portion 106 can conduct a test of the system-on-chip 100 by causing the domains 102 and the fabrics 104 to execute, based on the test command 306 and the one or more parameters 204-1, the test involving the test functions of the system-on-chip 100.

The TKSC 108-1 may bind the TM key 114 to a specific lifecycle state or otherwise include a feature to disable characteristics of a particular lifecycle state that negatively affect a test. In other words, the hardware test portion 106-1 may authenticate a first TM key 114 in a first lifecycle state but not authenticate the TM key 114 in a second different lifecycle state that comes after the first lifecycle state. The TKSC 108-1 may define TM keys like the TM key 114 with a specific functionality test associated with them.

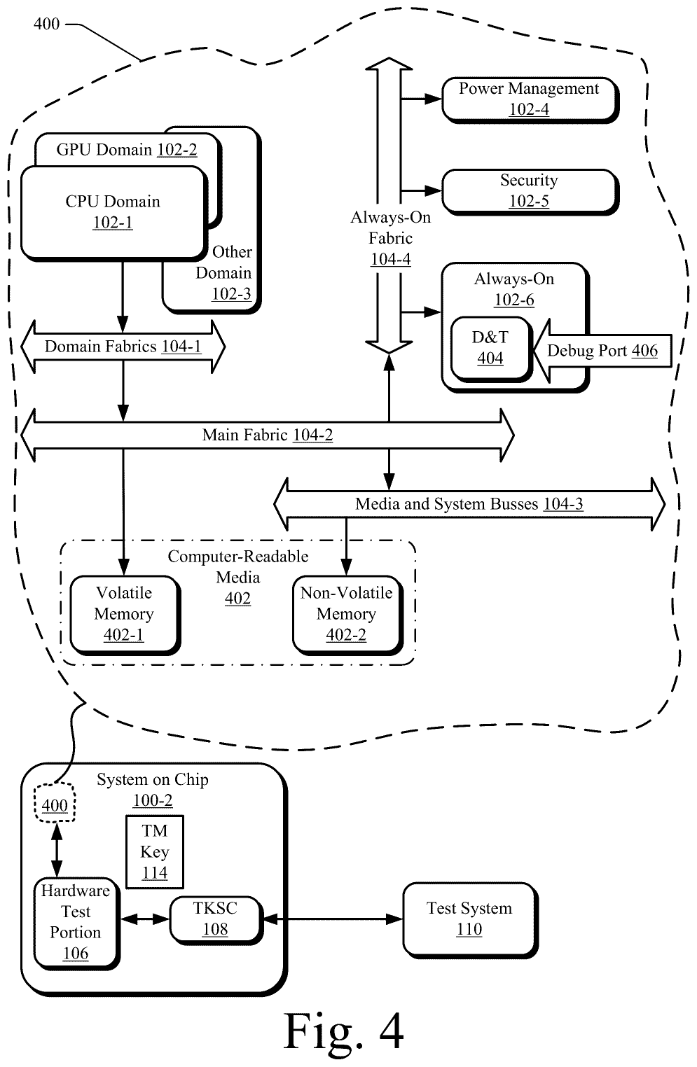

FIG. 4 illustrates another example system-on-chip that is configured to implement testing-and-manufacturing keys, in accordance with techniques of this disclosure. A system-on-chip 100-2 is an example of the system-on-chips 100 and 100-1. The system-on-chip 100-2 includes a functional portion 400, showing the domains 102 and the fabrics 104 in more detail. The system-on-chip 100-2 includes a central processing unit (CPU) domain 102-1, a graphics processing unit (GPU) domain 102-2, and a third or “other” domain 102-3. The domains 102-1 through 102-3 can communicate through domain fabrics 104-1, which feed a main fabric 104-2 and eventually reach a computer-readable media 402, for example a volatile memory 402-1. The main fabric 104-2 can also interconnect the domains 102-1 through 102-6 to a media and system busses 104-3, which can interface with the computer-readable media 402, including a non-volatile memory 402-2. A power management domain 102-4, a security domain 102-5, and an always-on domain 102-6 each communicate through an always-on fabric 104-4, which feeds the main fabric 104-2 in a manner similar to how the domain fabrics 104-1 interface with the main fabric 104-2.

The hardware test portion 106 is configured to cause the one or more domains 102-1 through 102-6 to execute instructions that verify whether the domains 102-1 through 102-6 of the system-on-chip 100-2 pass or fail the test. For example, the hardware test portion 106-1 executes one or more instructions that utilize the CPU domain 102-1. By causing the one or more fabrics 104-1 through 104-3 to carry data, the hardware test portion 106 can verify whether the fabrics 104-1 through 104-3 of the system-on-chip 100-2 pass or fail the test. For instance, in checking the CPU domain 102-1, the hardware test portion 106-1 invariable also checks the domain and main fabrics 104-1, 104-2.

For example, in conducting a test of the system-on-chip 100-2, the hardware test portion 106 may exercise a sufficiently large quantity of functional blocks in the system-on-chip 100-2 to verify that they can be used for the purpose they are intended. This can include calling on functions to exercise the domains 102-1 through 102-6 and the fabrics 104-1 through 104-4 by providing test vectors as inputs to the different functional blocks being tested. The computer-readable media 402 or other memories of the system-on-chip 100-2 can be tested by executing a predetermined test routine or “test pattern” or checksum.

As some additional examples, the hardware test portion 106 may test the system-on-chip 100-2 by driving internal cores of the CPU domain 102-1, the GPU domain 102-2, or other internal cores and specialized processing units by executing a predetermined test routine with an expected result. Register-level access to the domains 102-1 through 102-6 may be restricted to promote security in the event the hardware test portion 106 becomes corrupted.

The hardware test portion 106 can, if a test calls for it, load executable instructions into the volatile memory 402-1 to cause the system-on-chip 100-2 to function with some (e.g., limited) functionality. Any domain or fabric that is under test is made unavailable until a test is complete. The non-volatile memory 402-2 is restricted to prevent an attack through the hardware test portion 106-1 of storage and prevents attacks against stored system code through misuse of test keys.

An ability of the hardware test portion 106-1 to interact with security enclaves or other secrets stored on-chip may be limited to various predetermined messages. For example, the hardware test portion 106-1 may be able to pass a default or “null” message to the security domain 102-5 over a dedicated bus or dedicated mailbox in the always-on fabric 104-4 and read a predetermined response from the security domain 102-5. A limited set of predefined messages that are available to the hardware test portion 106 prevent the leaking of secrets from the security domain 102-5. The hardware test portion 106-1 may trigger a built-in self-test (BIST) feature of the security domain 102-5 and read back the test results in a predetermined format that limits potential leaks.

The hardware test portion 106 can test whether on-chip non-volatile secrets are present. For example, the hardware test portion 106 triggers a checksum or error correction function to test if the checksum is present and read the results in a predetermined format to also limit potential leaks. The hardware test portion 106 may not have write access to these types of secrets but can read and verify their existence.

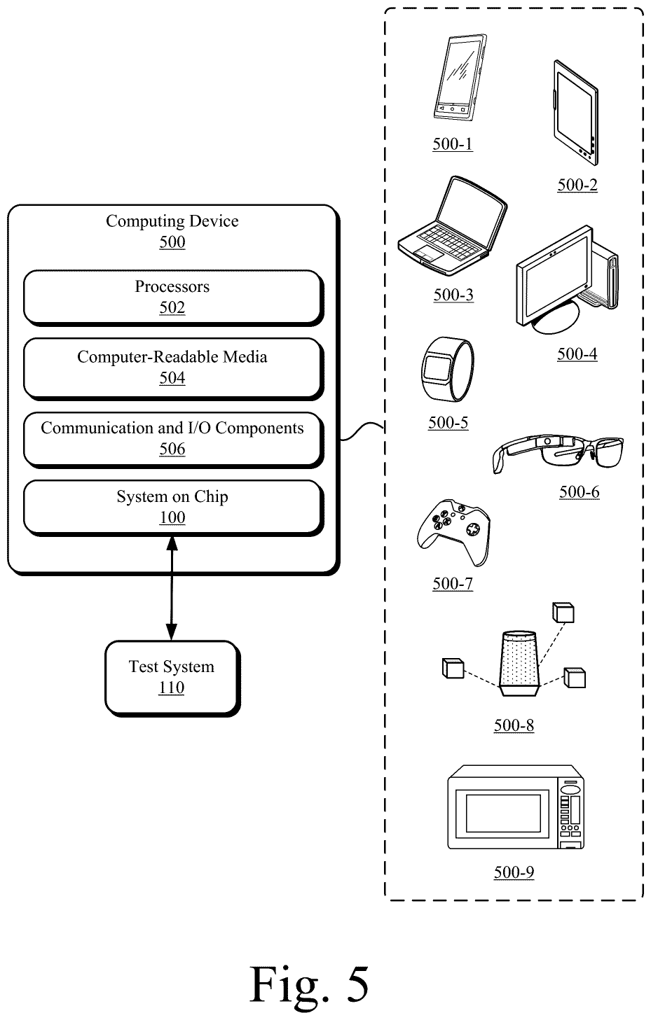

FIG. 5 illustrates an example computing environment in which an example system-on-chip is configured to implement testing-and-manufacturing keys in accordance with techniques of this disclosure. The computing device 500 is an example of a computing environment that is physically connected by the system-on-chip 100 to the test system 110. As some examples, the computing device 500 can be a mobile phone 500-1, a table device 500-2, a laptop computer 500-3, a desktop computer or workstation 500-4, a computerized watch 500-5, computerized eyeglasses 500-6, a handheld controller 500-7, an intelligent speaker system 500-8, and an appliance 500-9.

The computing device 500 includes one or more processors 502 and a computer-readable media 504 configured to store instructions that are executable by the one or more processors 502. The computing device 500 further includes one or more communication and input/output (I/O) components 506 and the system-on-chip 100. In some examples, the system-on-chip 100 replaces some or all of the functionality of the processors 502, the computer-readable media 504, and/or the communication and I/O components 506. In other words, in simplest of forms, the computing device 500 includes the system-on-chip 100, which is configured as the processors 502, the computer-readable media 504, and the communication and I/O components 506.

The processors 502 and the computer-readable media 504, which include memory media and storage media, are a processing complex of the computing device 500. The processors 502 may include any combination of one or more controllers, microcontrollers, processors, microprocessors, hardware processors, hardware processing units, digital-signal-processors, graphics processors, graphics processing units, and the like. The processor 502 may be an integrated processor and memory subsystem implemented as the system-on-chip 100, which processes computer-executable instructions to control operations of the computing device 500.

The computer-readable media 504 is configurable for persistent and non-persistent storage of executable instructions (e.g., firmware, software, applications, modules, programs, functions) and data (e.g., user data, operational data, online data) to support execution of the executable instructions. Examples of the computer-readable media 504 include volatile memory and non-volatile memory, fixed and removable media devices, and any suitable memory device or electronic data storage that maintains executable instructions and supporting data. The computer-readable media 504 can include various implementations of random-access memory (RAM), read-only memory (ROM), flash memory, and other types of storage memory in various memory device configurations. The computer-readable media 504 excludes propagating signals. The computer-readable media 504 may be a solid-state drive (SSD) or a hard disk drive (HDD).

The processors 502 are operatively coupled to the one or more communication and I/O components 506. The communication and I/O components 506 include data network interfaces that provide connection and/or communication links between the device and other data networks, devices, or remote systems (e.g., servers). The communication and I/O components 506 couples the computing device 500 to a variety of different types of components, peripherals, or accessory devices. Data input ports of the communication and I/O components 506 receive data, including image data, user inputs, communication data, audio data, video data, and the like. The communication and I/O components 506 enable wired or wireless communicating of device data between the computing device 500 and other devices, computing systems, and networks. Transceivers of the communication and I/O components 506 enable cellular phone communication and other types of network data communication.

The one or more communication and I/O components 506 may include a display, for example a screen and a region of pixels positioned beneath the screen, for example, an organic light-emitting diode (OLED) display. The one or more communication and I/O components 506 may include one or more sensors, for example, embedded within the display or as a separate component of the computing device 500. The communication and I/O component 506 provide connectivity between the computing device 500, a user, and other devices and peripherals in the outside world.

The computing device 500 may output a user interface from which a developer or programmer can provide user inputs to the computing device 500. For example, a display of the communication and I/O components 506 may present a graphical user interface from which a human operator of the test system 110 can select options that generate a testing-and-manufacturing token to test the system-on-chip 100 using the testing-and-manufacturing keys.

### Example Processes

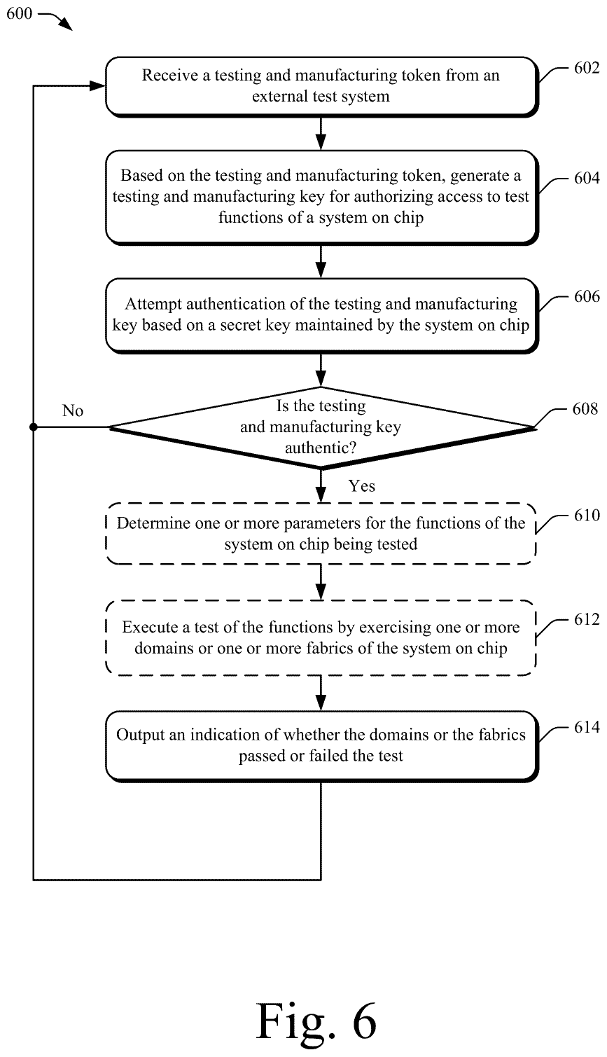

FIG. 6 illustrates an example process performed by an example system-on-chip that is configured to implement testing-and-manufacturing keys in accordance with techniques of this disclosure. Operations 602 through 612 of the process 600 can be performed in a different order and with additional or fewer operations than that shown in FIG. 6.

At 602, a testing-and-manufacturing token is received from an external test system. For example, the TKSC 108 receives the TM token 112 from the test system 110. After wakeup, the TKSC 108 generates a sign of life signal to be picked up by the test system 110 and then enters a timed wait loop. If the wait loop expires, the TKSC may return to 602.

At 604, based on the testing-and-manufacturing token, a testing-and-manufacturing key for authorizing access to test functions of a system-on-chip is generated. The TKSC 108 may generate the TM key 114 based on the TM token 112.

At 606, an authentication of the testing-and-manufacturing key is attempted based on a secret key maintained by the system-on-chip. For example, the hardware test portion 106 receives the TM key 114 after the TKSC 108 authenticates the TM key 114 using a secret key maintained by the TKSC 108 (e.g., the secret key 210).

At 608, it is determined whether the testing-and-manufacturing key is authentic. If it is determined that the testing-and-manufacturing key is authentic, then at 610, one or more parameters for the functions of the system-on-chip being tested are determined. For example, the hardware test portion 106 analyzes the parameters transmitted by the TKSC 108 with the TM key 114 to initialize registers or other components of the hardware test portion 106 to get ready for a test.

Otherwise, at 608, if it is determined that the testing-and-manufacturing key is not authentic, then the process 600 returns to 602 to repeat the process 600 in response to receiving another testing-and-manufacturing token. For instance, the system-on-chip 100 outputs an error via the TKSC 108-1 that is received by the test system 110. The error can be a human or machine-readable message indicating that the TM token 112 received is not able to be authenticated. This means that, responsive to failing to authenticate the TM key 114 based on the secret key, the system-on-chip 100 (e.g., the hardware test portion 106) refrains from executing the test involving the test functions of the system-on-chip 100 to protect the test functions and other secrets maintained by the system-on-chip 100.

At 612, a test of the functions is executed by exercising one or more domains or one or more fabrics of the system-on-chip. For example, the hardware test portion 106-1 causes the fabrics 104 to transport data that is handled by the domains 102, which are configured to execute the test.

At 614, an indication of whether the domains or the fabrics passed or failed the test is output before the process 600 returns to 602 to repeat the process 600 in response to receiving another testing-and-manufacturing token. The system-on-chip 100 may output a success via the TKSC 108-1 that is received by the test system 110. In contrast to an error, the success can be a human or machine-readable message indicating whether the domains 102 and the fabrics 104 passed the test.

As an example of repeating the process 600, the system-on-chip 100 may receive, from the test system 110, another TM token for the test system 110. For example, in response to receiving the error at 608, the test system 110 may generate another token to be used as the TM token 112.

The TKSC 108 may generate, based on the new TM token 112, another key to be used as the TM key 114 for authorizing access to the test functions of the system-on-chip 100. The TKSC 108 may attempt authentication of the new TM key 114 based on the secret key maintained by the system-on-chip 100. Responsive to failing to authenticate the other testing-and-manufacturing key based on the secret key, the hardware test portion 106 refrains from executing the test involving the test functions of the system-on-chip 100. This secures the test functions and other secrets maintained by the system-on-chip 100.

Some additional examples of processes for implementing testing-and-manufacturing keys for a system-on-chip are described in the following section of examples.

Example 1. A method comprising: receiving, by a system-on-chip, from an external test system, a testing-and-manufacturing token for the external test system; generating, by the system-on-chip and based on the testing-and-manufacturing token, a testing-and-manufacturing key for authorizing access to test functions of the system-on-chip; attempting authentication of the testing-and-manufacturing key based on a secret key maintained by the system-on-chip; responsive to authenticating the testing-and-manufacturing key based on the secret key, outputting, to the external test system, an indication of whether one or more domains or one or more fabrics of the system-on-chip passed or failed a test involving the test functions of the system-on-chip.

Example 2. The method of the preceding example, further comprising causing the one or more domains to execute instructions that check whether the one or more domains of the system-on-chip pass or fail the test functions of the system-on-chip.

Example 3. The method of any of the preceding examples, further comprising: causing the one or more fabrics to carry data during a check of whether the one or more fabrics of the system-on-chip pass or fail the test functions of the system-on-chip.

Example 4. The method of any of the preceding examples, wherein receiving the testing-and-manufacturing token for the external test system comprises receiving the testing-and-manufacturing token using a testing-and-manufacturing security component of the system-on-chip that is physically coupled to the external test system.

Example 5. The method of any of the preceding examples, wherein generating the testing-and-manufacturing key comprises generating the testing-and-manufacturing key using the testing-and-manufacturing security component of the system-on-chip when physically coupled to the external test system.

Example 6. The method of claim 5, wherein the testing-and-manufacturing token comprises an authorization payload and an identification segment that is indicative of the one or more domains and the one or more fabrics intended for a test, and generating the testing-and-manufacturing key comprises generating, based in part on the authorization payload and the identification segment, the testing-and-manufacturing key.

Example 7. The method of any of the preceding examples, further comprising transitioning the testing-and-manufacturing security component from a dormant state to a wake state in response detecting the external test system that is physically coupled to the system-on-chip.

Example 8. The method of any of the preceding examples, wherein attempting authentication of the testing-and-manufacturing key based on the secret key comprises: maintaining, by the testing-and-manufacturing security component, the secret key; and responsive to the testing-and-manufacturing security component authenticating the testing-and-manufacturing key, executing the test using a hardware test portion that is separate from the testing-and-manufacturing security component.

Example 9. The method of any of the preceding examples, wherein the hardware test portion is communicatively isolated from the external test system.

Example 10. The method of any of the preceding examples, wherein the testing-and-manufacturing token further comprises a test command and one or more parameters, the method further comprising: further responsive to authenticating the testing-and-manufacturing key based on the secret key, executing, based on the test command and the one or more parameters, the test involving the test functions of the system-on-chip.

Example 11. The method of any of the preceding examples, further comprising receiving, by the hardware test portion and from the testing-and-manufacturing security component of the system-on-chip, a signal indicative of the testing-and-manufacturing key.

Example 12. The method of any of the preceding examples, wherein the signal is further indicative of one or more parameters for the test functions.

Example 13. The method of any of the preceding examples, further comprising: receiving, by the system-on-chip, from the external test system, another testing-and-manufacturing token for the external test system; generating, by the system-on-chip, based on the other testing-and-manufacturing token, another testing-and-manufacturing key for authorizing access to the test functions of the system-on-chip; attempting authentication of the other testing-and-manufacturing key based on the secret key maintained by the system-on-chip; responsive to failing to authenticate the other testing-and-manufacturing key based on the secret key, refraining, by the system-on-chip, from executing the test involving the test functions of the system-on-chip to protect the test functions and other secrets maintained by the system-on-chip.

Example 14. A system-on-chip configured to perform the method of any of the preceding examples.

Example 15. A computing device comprising the system-on-chip of the example 14.

### CONCLUSION

While various embodiments of the disclosure are described in the foregoing Description and shown in the Drawings, it is to be understood that this disclosure is not limited thereto but may be variously embodied to practice within the scope of the following claims. From the foregoing Description, it will be apparent that various changes may be made without departing from the spirit and scope of the disclosure as defined by the following claims.

The use of “or” and grammatically related terms indicates non-exclusive alternatives without limitation unless the context clearly dictates otherwise. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

1. A method comprising:
receiving, by a system-on-chip, from an external test system, a testing-and-manufacturing token for the external test system;
generating, by the system-on-chip and based on the testing-and-manufacturing token, a testing-and-manufacturing key for authorizing access to test functions of the system-on-chip;
attempting authentication of the testing-and-manufacturing key based on a secret key maintained by the system-on-chip; and
responsive to authenticating the testing-and-manufacturing key based on the secret key, outputting, to the external test system, an indication of whether one or more domains or one or more fabrics of the system-on-chip passed or failed a test involving the test functions of the system-on-chip.

2. The method of claim 1, further comprising:
causing the one or more domains to execute instructions that check whether the one or more domains of the system-on-chip pass or fail the test functions of the system-on-chip.

3. The method of claim 1, further comprising:
causing the one or more fabrics to carry data during a check of whether the one or more fabrics of the system-on-chip pass or fail the test functions of the system-on-chip.

4. The method of claim 1, wherein receiving the testing-and-manufacturing token for the external test system comprises receiving the testing-and-manufacturing token using a testing-and-manufacturing security component of the system-on-chip that is physically coupled to the external test system.

5. The method of claim 4, wherein generating the testing-and-manufacturing key comprises generating the testing-and-manufacturing key using the testing-and-manufacturing security component of the system-on-chip.

6. The method of claim 5, wherein the testing-and-manufacturing token comprises an authorization payload and an identification segment that is indicative of the one or more domains and the one or more fabrics intended for a test, and generating the testing-and-manufacturing key comprises generating, based in part on the authorization payload and the identification segment, the testing-and-manufacturing key.

7. The method of claim 4, further comprising:
transitioning the testing-and-manufacturing security component from a dormant state to a wake state in response detecting the external test system that is physically coupled to the system-on-chip.

8. The method of claim 4, wherein attempting authentication of the testing-and-manufacturing key based on the secret key comprises:
maintaining, by the testing-and-manufacturing security component, the secret key; and
responsive to the testing-and-manufacturing security component authenticating the testing-and-manufacturing key, executing the test using a hardware test portion that is separate from the testing-and-manufacturing security component.

9. The method of claim 8, wherein the hardware test portion is communicatively isolated from the external test system.

10. The method of claim 9, wherein the testing-and-manufacturing token further comprises a test command and one or more parameters, the method further comprising:
further responsive to authenticating the testing-and-manufacturing key based on the secret key, executing, based on the test command and the one or more parameters, the test involving the test functions of the system-on-chip.

11. The method of claim 4, further comprising:
receiving, by the hardware test portion and from the testing-and-manufacturing security component of the system-on-chip, a signal indicative of the testing-and-manufacturing key.

12. The method of claim 11, wherein the signal is further indicative of one or more parameters for the test functions.

13. The method of claim 1, further comprising:
receiving, by the system-on-chip, from the external test system, another testing-and-manufacturing token for the external test system;
generating, by the system-on-chip, based on the other testing-and-manufacturing token, another testing-and-manufacturing key for authorizing access to the test functions of the system-on-chip;
attempting authentication of the other testing-and-manufacturing key based on the secret key maintained by the system-on-chip; and
responsive to failing to authenticate the other testing-and-manufacturing key based on the secret key, refraining, by the system-on-chip, from executing the test involving the test functions of the system-on-chip to protect the test functions and other secrets maintained by the system-on-chip.

14. (canceled)

15. (canceled)

16. A system-on-chip comprising:
one or more processors; and
memory storing one or more programs to be executed by the one or more processors, the one or more programs comprising instructions for:
receiving, by a system-on-chip, from an external test system, a testing-and-manufacturing token for the external test system;
generating, by the system-on-chip and based on the testing-and-manufacturing token, a testing-and-manufacturing key for authorizing access to test functions of the system-on-chip;
attempting authentication of the testing-and-manufacturing key based on a secret key maintained by the system-on-chip; and
responsive to authenticating the testing-and-manufacturing key based on the secret key, outputting, to the external test system, an indication of whether one or more domains or one or more fabrics of the system-on-chip passed or failed a test involving the test functions of the system-on-chip.

17. The system-on-chip of claim 16, wherein the one or more programs further comprise instructions for at least one of:
causing the one or more domains to execute instructions that check whether the one or more domains of the system-on-chip pass or fail the test functions of the system-on-chip; or
causing the one or more fabrics to carry data during a check of whether the one or more fabrics of the system-on-chip pass or fail the test functions of the system-on-chip.

18. The system-on-chip of claim 16, wherein receiving the testing-and-manufacturing token for the external test system comprises receiving the testing-and-manufacturing token using a testing-and-manufacturing security component of the system-on-chip that is physically coupled to the external test system.

19. The system-on-chip of claim 18, wherein generating the testing-and-manufacturing key comprises generating the testing-and-manufacturing key using the testing-and-manufacturing security component of the system-on-chip.

20. The system-on-chip of claim 19, wherein the testing-and-manufacturing token comprises an authorization payload and an identification segment that is indicative of the one or more domains and the one or more fabrics intended for a test, and generating the testing-and-manufacturing key comprises generating, based in part on the authorization payload and the identification segment, the testing-and-manufacturing key.

21. The system-on-chip of claim 18, wherein the one or more programs further comprise instructions for:
transitioning the testing-and-manufacturing security component from a dormant state to a wake state in response detecting the external test system that is physically coupled to the system-on-chip.

22. The system-on-chip of claim 18, wherein attempting authentication of the testing-and-manufacturing key based on the secret key comprises:
maintaining, by the testing-and-manufacturing security component, the secret key; and
responsive to the testing-and-manufacturing security component authenticating the testing-and-manufacturing key, executing the test using a hardware test portion that is separate from the testing-and-manufacturing security component.
